(19) United States
(12) Patent Application Publication
(10) Pub. No.: US 2006/0195544 A1
(43) Pub. Date: Aug. 31, 2006

(54) Posting and receiving resources for external applications using a web browser as an agent

(75) Inventors: Bill Chan, Sunnyvale, CA (US); Chong Yea Shaw, Sunnyvale, CA (US)

Correspondence Address: BCKS, P. O. BOX 64402, SUNNYVALE, CA, 94088-4402, US

(73) Assignee: BCKS, Sunnyvale, CA (US)

(21) Appl. No.: 10/906,650

(22) Filed: Feb. 28, 2005

(51) Int. Cl. G06F 15/167

(52) U.S. Cl. 709/216

(57) ABSTRACT

This application describes a novel method and apparatus to post to and receive resources from a global communication network via an alternative global communication network connection facilitated by a web browser acting as an agent. A web browser normally sends a request to a web server which responds to said request by sending a web page back to said web browser. Said request can also be designed to cause said web server to create files and data intended for an application external to said web browser in said user local system. Said web browser facilitates said application receiving said files and data via an alternative global communication network connection as described herein.

### BACKGROUND OF THE INVENTION

In prior art, a computer user will use a web browser to send a request to a web server and receive a web page from said web server. Said web browser will display HTML documents directly. If there are references to images, sound clips, lava applets, etc. in said document and said browser has been set up to display these, said web browser will request these from the web servers on which they reside. Said web servers do not have to be the web server on which the document resides.

For example, said web browser sends a request with the URL for an initial web page to said web server. Said web server responds by sending the requested web page back to said web browser. Said web browser analyzes said web page from said web server and finds the URL's for nine images in said web page. Said web browser sends said web server nine URL requests. Said web server responds by sending said nine images to said web browser. This completes the file transfer between said web browser and said web server.

The web browser receives only resources created by said web server when said web server responds to the URL request from said web browser. Said web server can create resources which said web server does not send to said web browser; these resources to be intended for an application in said user local system external to said web browser.

In the example described above, said web server, by some predetermined business logic responding to said web browser request, can create two more files and post these files to a resource server. Said web browser would not have access to these resources. Prior art with said web browser does not allow said user local system access to these resources or update a local database via a standard or customized application protocol.

### DESCRIPTION OF THE INVENTION

The method and apparatus of this invention is a user local system as described in claim 1 to consist of a local computer with at minimum, 1) a storage means such as a hard drive, 2) a communication means such as a modem for connecting to a global communication network, 3) an output means such as an LCD panel, and 4) an input means such as a keyboard. Furthermore, said user local system is implemented with A) a user interface, B) a web browser, C) a relay agent, and D) an application.

As example of the implementation of said user interface A), said user interface may produce the image of a “button” on said output means 3 of said user local system. Clicking on said button with said input means 4 activates a link.

Activating said link causes said user interface to locate a node id found in the user local system and create a URL embedded with said node id to uniquely identify said user local system for posting information to a remote web resource server. Activating said link also starts web browser B and causes said web browser to follow said URL with said embedded node id. Said web browser sends a request to a remote web server. Said web server processes the request and sends a response web page or cookies to said web browser. Said remote web resource server and said remote web server may be the same machine operating in different capacities as described herein.

Activating said link also starts relay agent C. Said relay agent will send said node id and make a persistent network connection to a remote relay server. Said relay server provides the alternative global communication connection for any resources created by said web server intended for said external application in said user local system.

In the event said web browser request initiates said web server to create resources intended for said external application located on said user local system; said web server sends tokens of said resources and the node id of said user local system to said relay server. Said relay server processes and sends said tokens of said resources to said relay agent via the corresponding persistent network connection. Said relay agent processes said tokens of said resources and sends a request with node id embedded to a resource server for said resources. Said resource server processes the request and sends the requested resources via a standard (such as HTTP) or a customized application protocol to said relay agent. Said relay agent saves said resources into a user-defined area in the storage device in said user local system. Said relay agent can update a database on said user local system or communicate with said resource server to let said web server update a local database via a standard or customized application protocol.

### FIGURES

FIG. 1 illustrates prior art. A web browser sends a request with an embedded URL to a remote web server at procedure 100. Said web server processes the URL and sends the response web page to said web browser at procedure 101. Said web browser processes the received web page and sends requests for all the URLs of graphics and sound in the web page to said web server. Each said URL request results in said web browser receiving one response file. Said user local system displays the web page on its display screen or plays the files on its sound card. Said web browser acts as web page viewer to view the web page including all files with URLs of graphic images and sound in the web page.

FIG. 2 is an overview of the method and apparatus of claim 1. It consists of six basic components. A. a user local system, B. a user interface C, a web browser, D. a relay agent, E. resources, and F. an application. The user local system communicates with servers via a global communication network such as the Internet.

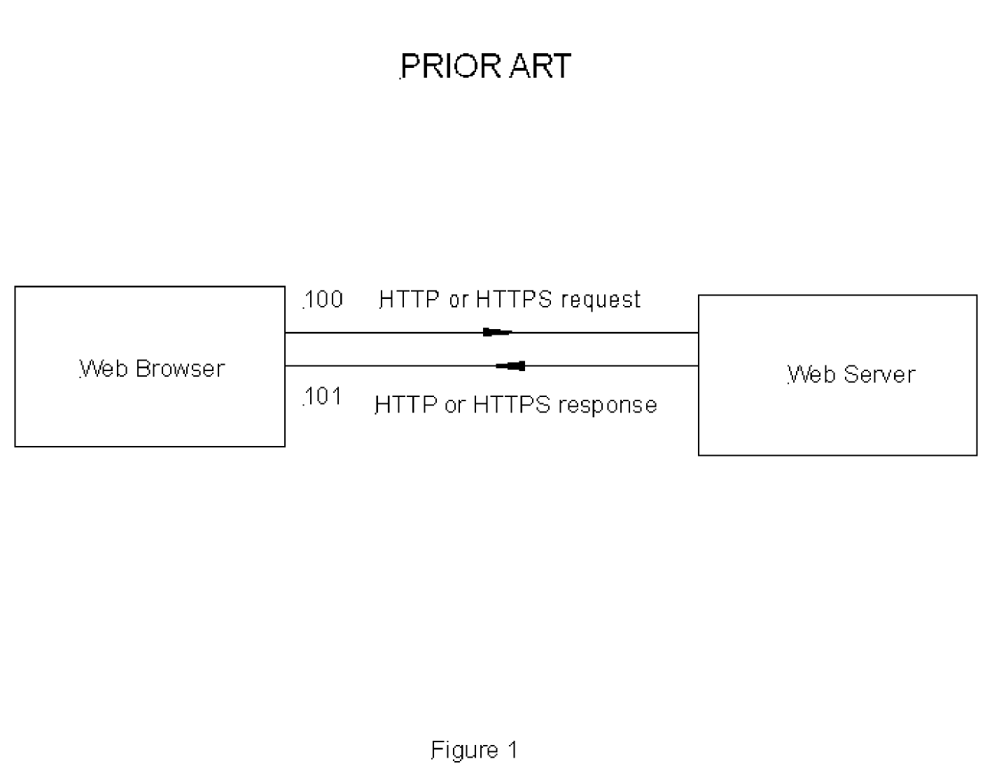

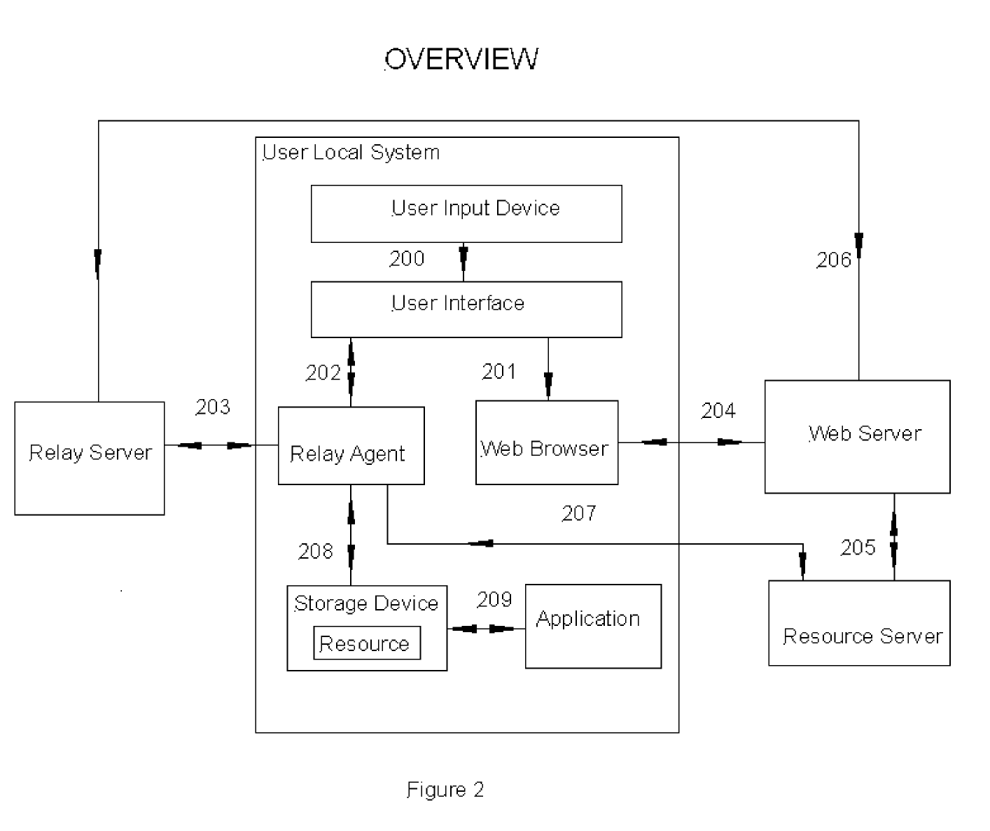

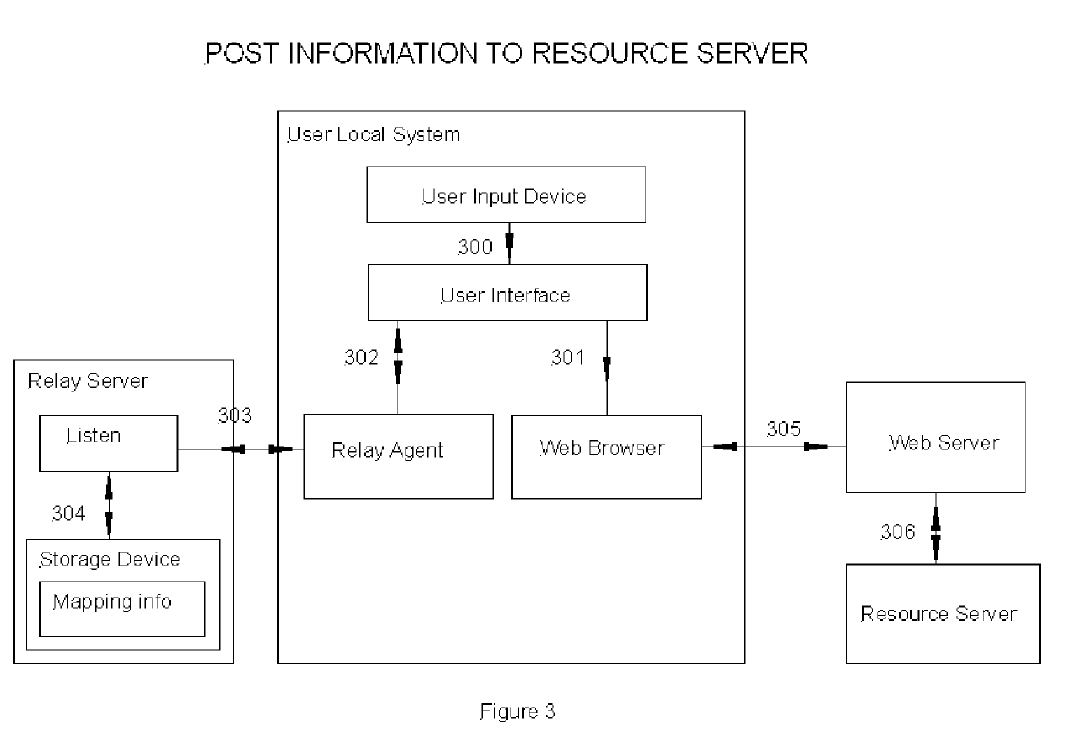

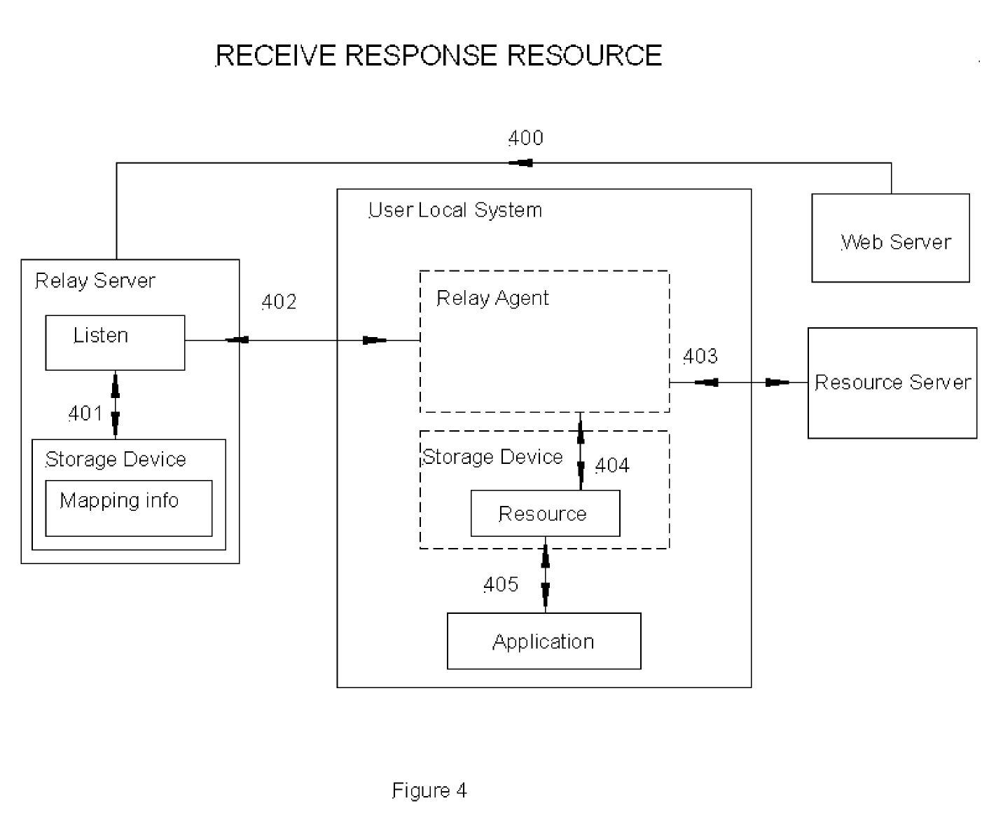

The local system operator uses a user input device such a keyboard to communicate with said user interface B at procedure 200. Said user interface accepts the user input and activates said web browser C at procedure 201 and said relay agent D at procedure 202.

Said web browser sends a request to a web server and receives a corresponding response from said web server at procedure 204. Should said web browser request be designed to initiate it, said web server processes said request, creates said resources E, and saves said resources for said application F to a resource server at procedure 205. Said web server sends the tokens of said resources to a relay server at procedure 206.

A relay agent is used for establishing a persistent network connection with said relay server at procedure 203. Communication with said relay server is by control message at procedure 203. Said relay agent sends a request to said resource server and receives said resources from said resource server at procedure 207. Said relay agent saves said resources at procedure 208. Said application F utilizes said resources received by said relay agent at procedure 209.

FIG. 3 illustrates how the method and apparatus of claim 1 is used to post information to a resource server. The local system operator uses a user input device such as a keyboard to communicate with the user interface at procedure 300. For example, said user interface places a button on the display screen of said user local system.

Clicking on said button at procedure 300 causes said user interface to locate a node id found in the user local system. Said user interface creates a URL embedded with said node id to uniquely identify the user local system. Said URL is designed to prepare a remote web server to create and store resources on a resource server.

Clicking on said button also activates a link causing said user local system to start a web browser at procedure 301 and a relay agent at procedure 302.

Said relay agent sends the user local system node id and establishes a persistent network connection to a relay server at procedure 303. Said relay server saves the mapping information of the node id and persistent network connection in a storage device at procedure 304.

Said web browser sends said URL with said node id to a web server at procedure 305, The web server processes the URL and sends a response web page to said web browser at procedure 305. A “web submit form” is an example of such a response web page. The user fills out information in said form and returns said form to said web server Said web server, for example, sends a response to said web browser indicating the submission is complete and accepted. Said web server then processes the form and posts the information (the resources) to a resource server at procedure 306. Said information is saved into files or data on said resource server. The persistent network connection remains active so said user local system is able to receive the resources as described in FIG. 4.

FIG. 4 illustrates in further detail how the method and apparatus of claim 1 receives resources intended for an external application. A web server sends tokens of said resources with user local system node id embedded to a relay server at procedure 400. Said relay server locates the mapping information of said node id and persistent network connection of said user local system at procedure 401.

Said relay server processes and sends said tokens of said resources to said user local system relay agent at procedure 402 via the corresponding persistent network connection located by the mapping information of said node id and said persistent network connection. Said relay agent processes said tokens of said resources and sends a request with node id embedded to said resource server for said resources at procedure 403. Said resource server processes the request and sends the requested resources to said relay agent at procedure 403. Said relay agent processes the response and receives the resources. Said relay agent saves the resources at procedure 404. An application can process and utilize the resources at procedure 405.

What is claimed is:

1. We claim a novel method and apparatus for a user local system to post to and receive resources from a global communication network facilitated by the use of a web browser. A web server at the behest of said web browser creates said resources. Said resources can but do not have to be web pages. Said resources are passed to and from said user local system via an alternative global communication network connection. Said resources are to be used by an application program residing on said user local system. Said apparatus to include the following, A. a user local system, B. a user interface, C. a web browser, D. a relay agent, E. said resources, and F. said application program. We claim that said user local system A, with user interface B, web browser C, and said relay agent D permits the user to obtain via an alternative global communication network connection, resources E, which can be utilized by said application F.
The term “user local system” herein refers to a user local computer with at minimum, 1) a storage means such as a hard drive, 2) a communication means such as a modem for connecting to a global communication network, 3) an output means such as an LCD panel, and 4) a user input device such as a keyboard. Other possible embodiments of said user local system include PDA's (personal digital assistants) and cell phones equipped with a browser and capable of being connected to a global communication network such as the Internet. The connection to said global communication network may be through a wired means or a wireless means. The term “local computer” for the purposes of this application can include as examples, IBM type PC's, Apple type computers, as wells as mainframe computers. For the purposes of this application, the term “external application” refers to programs other than said web browser C.
